(19) United States
(12) Patent Application Publication
(10) Pub. No.: US 2014/0292617 A1
(43) Pub. Date: Oct. 2, 2014

(54) SYSTEM, METHOD, AND COMPUTER PROGRAM PRODUCT FOR REDUCING IMAGE ARTIFACTS ON MULTIPLE DISPLAYS

(71) Applicant: NVIDIA CORPORATION, Santa Clara, CA (US)

(72) Inventors: Antonio Tejada Lacaci, San Jose, CA (US); Martin Schwarzer, Gemmenich (BE)

(73) Assignee: NVIDIA Corporation, Santa Clara, CA (US)

(21) Appl. No.: 13/854,000

(22) Filed: Mar. 29, 2013

(51) Int. Cl. G06F 3/14

(52) U.S. Cl. CPC G06F 3/1423
USPC 345/1.2

(57) ABSTRACT

A system, method, and computer program product for synchronizing video signals transmitted to a plurality of display devices participating in a spanned desktop environment is disclosed. The method includes the steps of generating an image for display on a spanned desktop environment that includes a plurality of display devices, allocating a portion of the image to each display device in the plurality of display devices, and, for each display device, transmitting a video signal to the display device that represents the portion of the image allocated to that display device. The timing of each video signal is based on a relative position of the display device in a display grid.

### FIELD OF THE INVENTION

The present invention relates to computer-generated graphics, and more particularly to spanned desktop environments.

### BACKGROUND

Conventionally, a desktop computer or a laptop computer was connected to a single physical display device such as a cathode ray tube (CRT) monitor or a liquid crystal display (LCD) monitor. The physical display device typically included a cable for a particular type of video interface (e.g., VGA, DVI, etc.) to attach to a connector on the back of the computer. The connector was coupled to a graphics processing unit (GPU) that generated pixel data or video signals for display on the surface of the physical display device. More recently, computer systems began implementing multiple GPUs or single GPUs with multiple display connectors for attaching multiple monitors to the same computer. Desktop spanning (i.e., also known as multi-monitor, multi-display, or multi-head technology) enables a single video surface to be extended and displayed across multiple physical display devices.

However, spanning a single logical desktop surface across multiple display devices may introduce certain artifacts that affect the quality of the image seen by a user. For example, the image may need to be corrected to account for the bezel, or gap, between the display devices. Without correction, the edges may appear to have discontinuities across display devices based on the distance between a pixel on the edge of one display device and an adjacent pixel on the edge of another display device. Another image artifact that may be noticeable is that moving objects may appear to have discontinuities across adjacent display devices due to the refresh cycle of each individual display device. Thus, there is a need for addressing these issues and/or other issues associated with the prior art.

### SUMMARY

A system, method, and computer program product for synchronizing video signals transmitted to a plurality of display devices participating in a spanned desktop environment is disclosed. The method includes the steps of generating an image for display on a spanned desktop environment that includes a plurality of display devices, allocating a portion of the image to each display device in the plurality of display devices, and, for each display device, transmitting a video signal to the display device that represents the portion of the image allocated to that display device. The timing of each video signal is based on a relative position of the display device in a display grid.

### BRIEF DESCRIPTION OF THE DRAWINGS

FIG. 1 illustrates a flowchart of a method for synchronizing multiple display devices participating in a spanned desktop environment, in accordance with one embodiment;

FIG. 2 illustrates a parallel processing unit, according to one embodiment;

FIG. 3 illustrates the streaming multi-processor of FIG. 2, according to one embodiment;

FIG. 4 illustrates a system for implementing desktop spanning, in accordance with one embodiment;

FIG. 5A illustrates a spanned desktop environment showing a tearing artifact, in accordance with the prior art;

FIG. 5B illustrates a spanned desktop environment that implements an artifact correction technique, in accordance with one embodiment;

FIG. 5C shows a timing diagram for the video signals transmitted to the display devices participating in a spanned desktop environment, in accordance with one embodiment;

FIG. 6 illustrates a flowchart of a method for synchronizing multiple display devices participating in a spanned desktop environment, in accordance with another embodiment; and

FIG. 7 illustrates an exemplary system in which the various architecture and/or functionality of the various previous embodiments may be implemented.

### DETAILED DESCRIPTION

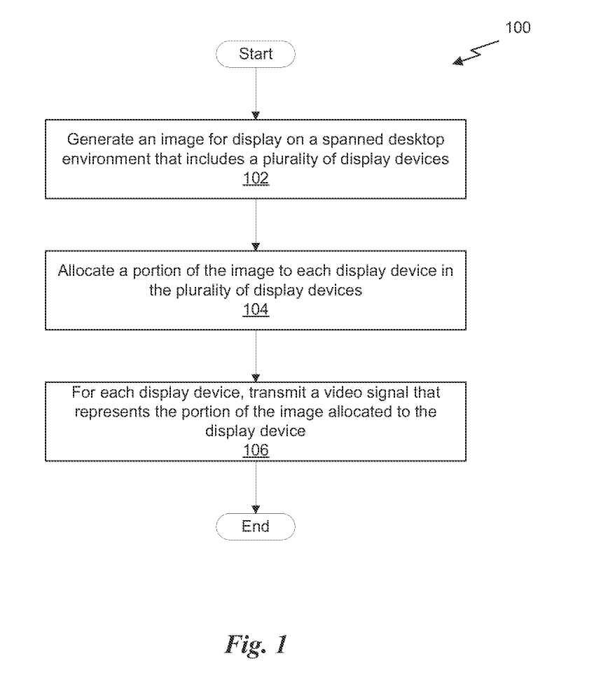

FIG. 1 illustrates a flowchart of a method 100 for synchronizing multiple display devices participating in a spanned desktop environment, in accordance with one embodiment. At step 102, an image is generated for display on a spanned desktop environment that includes a plurality of display devices. In one embodiment, the spanned desktop environment includes two or more display devices arranged in a two-dimensional (2D) array having m rows and n columns and a logical display surface (i.e., an image or a 2D array of pixel data stored in a memory) intended to be displayed across (i.e., span) the plurality of display devices. At step 104, a portion of the image is allocated to each display device in the plurality of the display devices. At step 106, a video signal is transmitted to each display device that represents the portion of the image allocated to the display device. The timing of each video signal is based on a position of the corresponding display device in the spanned desktop environment.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

For example, the method 100 of FIG. 1 may be implemented on one or more parallel processing units (e.g., graphics processing units) coupled to the plurality of display devices participating in the spanned desktop environment. At least one parallel processing unit may be configured to generate the image for display, allocate portions of the image to each of the display devices, and transmit delayed video signals to the display devices. The amount of delay of each video signal is based on the position of the display device corresponding to the video signal in the spanned desktop environment. A parallel processing unit will now be described for illustrative purposes. However, it will be appreciated that the foregoing framework may be implemented on other types of processors, such as a central processing unit, and that the architecture of the parallel processing unit should not be construed as limiting in any manner.

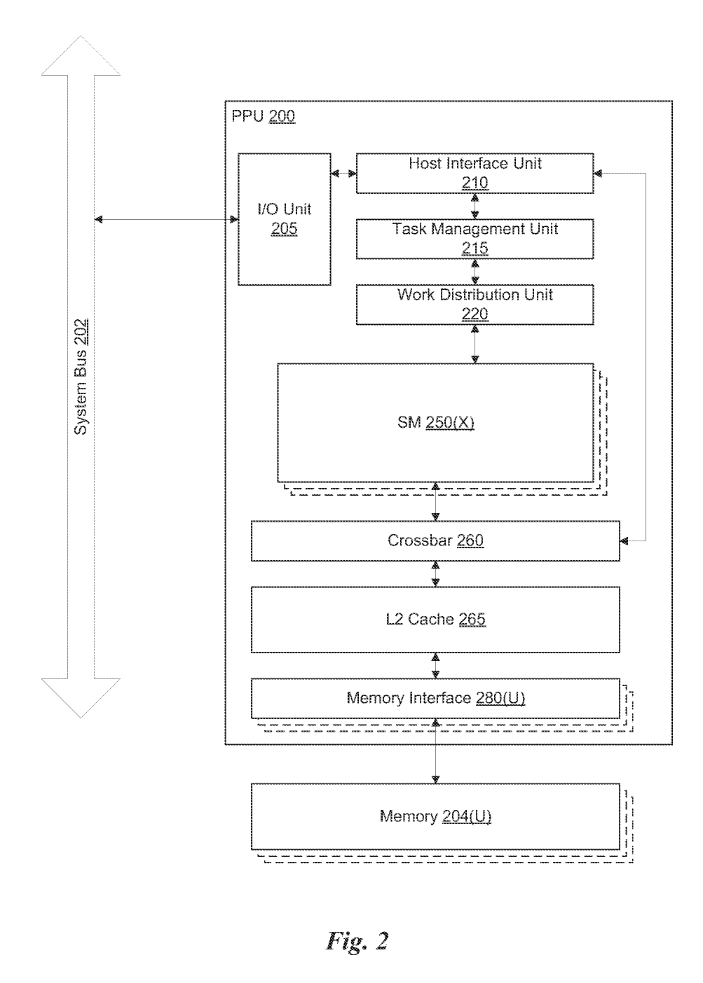

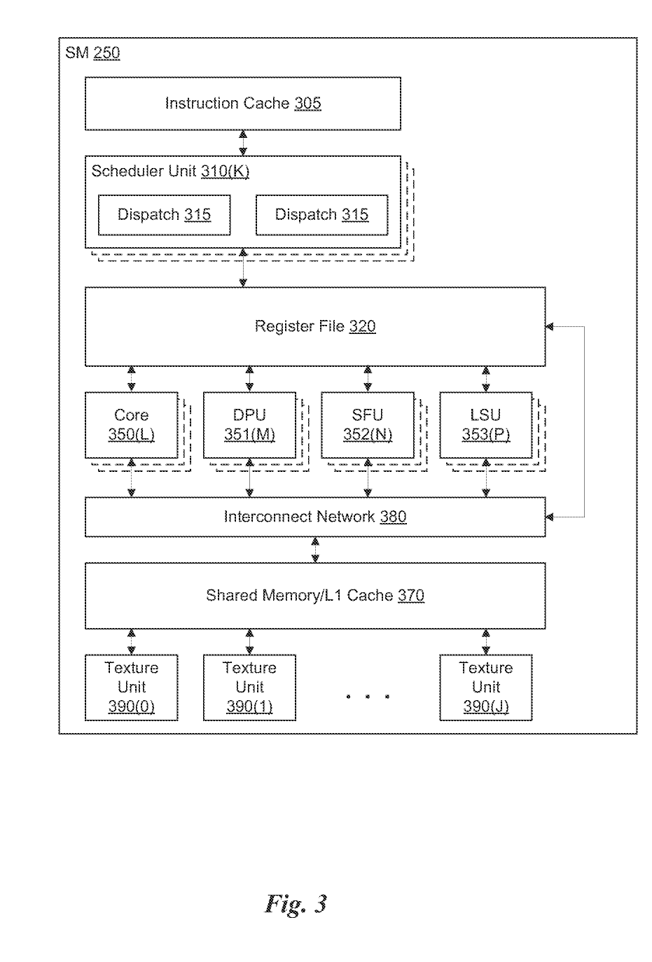

FIG. 2 illustrates a parallel processing unit (PPU) 200, according to one embodiment. While a parallel processor is provided herein as an example of the PPU 200, it should be strongly noted that such processor is set forth for illustrative purposes only, and any processor may be employed to supplement and/or substitute for the same. In one embodiment, the PPU 200 is configured to execute a plurality of threads concurrently in two or more streaming multi-processors (SMs) 250. A thread (i.e., a thread of execution) is an instantiation of a set of instructions executing within a particular SM 250. Each SM 250, described below in more detail in conjunction with FIG. 3, may include, but is not limited to, one or more processing cores, one or more load/store units (LSUs), a level-one (L1) cache, shared memory, and the like.

In one embodiment, the PPU 200 includes an input/output (I/O) unit 205 configured to transmit and receive communications (i.e., commands, data, etc.) from a central processing unit (CPU) (not shown) over the system bus 202. The I/O unit 205 may implement a Peripheral Component Interconnect Express (PCIe) interface for communications over a PCIe bus. In alternative embodiments, the I/O unit 205 may implement other types of well-known bus interfaces.

The PPU 200 also includes a host interface unit 210 that decodes the commands and transmits the commands to the task management unit 215 or other units of the PPU 200 (e.g., memory interface 280) as the commands may specify. The host interface unit 210 is configured to route communications between and among the various logical units of the PPU 200.

In one embodiment, a program encoded as a command stream is written to a buffer by the CPU. The buffer is a region in memory, e.g., memory 204 or system memory, that is accessible (i.e., read/write) by both the CPU and the PPU 200. The CPU writes the command stream to the buffer and then transmits a pointer to the start of the command stream to the PPU 200. The host interface unit 210 provides the task management unit (TMU) 215 with pointers to one or more streams. The TMU 215 selects one or more streams and is configured to organize the selected streams as a pool of pending grids. The pool of pending grids may include new grids that have not yet been selected for execution and grids that have been partially executed and have been suspended.

A work distribution unit 220 that is coupled between the TMU 215 and the SMs 250 manages a pool of active grids, selecting and dispatching active grids for execution by the SMs 250. Pending grids are transferred to the active grid pool by the TMU 215 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 220. In addition to receiving grids from the host interface unit 210 and the work distribution unit 220, the TMU 215 also receives grids that are dynamically generated by the SMs 250 during execution of a grid. These dynamically generated grids join the other pending grids in the pending grid pool.

In one embodiment, the CPU executes a driver kernel that implements an application programming interface (API) that enables one or more applications executing on the CPU to schedule operations for execution on the PPU 200. An application may include instructions (i.e., API calls) that cause the driver kernel to generate one or more grids for execution. In one embodiment, the PPU 200 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 200 comprises X SMs 250(X). For example, the PPU 200 may include 15 distinct SMs 250. Each SM 250 is multi-threaded and configured to execute a plurality of threads (e.g., 32 threads) from a particular thread block concurrently. Each of the SMs 250 is connected to a level-two (L2) cache 265 via a crossbar 260 (or other type of interconnect network). The L2 cache 265 is connected to one or more memory interfaces 280. Memory interfaces 280 implement 16, 32, 64, 128-bit data buses, or the like, for high-speed data transfer. In one embodiment, the PPU 200 comprises U memory interfaces 280(U), where each memory interface 280(U) is connected to a corresponding memory device 204(U). For example, PPU 200 may be connected to up to 6 memory devices 204, such as graphics double-data-rate, version 5, synchronous dynamic random access memory (GDDR5 SDRAM).

In one embodiment, the PPU 200 implements a multi-level memory hierarchy. The memory 204 is located off-chip in SDRAM coupled to the PPU 200. Data from the memory 204 may be fetched and stored in the L2 cache 265, which is located on-chip and is shared between the various SMs 250. In one embodiment, each of the SMs 250 also implements an L1 cache. The L1 cache is private memory that is dedicated to a particular SM 250. Each of the L1 caches is coupled to the shared L2 cache 265. Data from the L2 cache 265 may be fetched and stored in each of the L1 caches for processing in the functional units of the SMs 250.

In one embodiment, the PPU 200 comprises a graphics processing unit (GPU). The PPU 200 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 200 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes model data for a scene (i.e., a collection of vertices and attributes) to memory. The model data defines each of the objects that may be visible on a display. The application then makes an API call to the driver kernel that requests the model data to be rendered and displayed. The driver kernel reads the model data and writes commands to the buffer to perform one or more operations to process the model data. The commands may encode different shader programs including one or more of a vertex shader, hull shader, geometry shader, pixel shader, etc. For example, the TMU 215 may configure one or more SMs 250 to execute a vertex shader program that processes a number of vertices defined by the model data. In one embodiment, the TMU 215 may configure different SMs 250 to execute different shader programs concurrently. For example, a first subset of SMs 250 may be configured to execute a vertex shader program while a second subset of SMs 250 may be configured to execute a pixel shader program. The first subset of SMs 250 processes vertex data to produce processed vertex data and writes the processed vertex data to the L2 cache 265 and/or the memory 204. After the processed vertex data is rasterized (i.e., transformed from three-dimensional data into two-dimensional data in screen space) to produce fragment data, the second subset of SMs 250 executes a pixel shader to produce processed fragment data, which is then blended with other processed fragment data and written to the frame buffer in memory 204. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device or a plurality of display devices configured for desktop spanning.

The PPU 200 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 200 is embodied on a single semiconductor substrate. In another embodiment, the PPU 200 is included in a system-on-a-chip (SoC) along with one or more other logic units such as a reduced instruction set computer (RISC) CPU, a memory management unit (M MU), a digital-to-analog converter (DAC), and the like.

In one embodiment, the PPU 200 may be included on a graphics card that includes one or more memory devices 204 such as GDDR5 SDRAM. The graphics card may be configured to interface with a PCIe slot on a motherboard of a desktop computer that includes, e.g., a northbridge chipset and a southbridge chipset. In yet another embodiment, the PPU 200 may be an integrated graphics processing unit (iGPU) included in the chipset (i.e., Northbridge) of the motherboard.

FIG. 3 illustrates the streaming multi-processor 250 of FIG. 2, according to one embodiment. As shown in FIG. 3, the SM 250 includes an instruction cache 305, one or more scheduler units 310, a register file 320, one or more processing cores 350, one or more double precision units (DPUs) 351, one or more special function units (SFUs) 352, one or more load/store units (LSUs) 353, an interconnect network 380, a shared memory/L1 cache 370, and one or more texture units 390.

As described above, the work distribution unit 220 dispatches active grids for execution on one or more SMs 250 of the PPU 200. The scheduler unit 310 receives the grids from the work distribution unit 220 and manages instruction scheduling for one or more thread blocks of each active grid. The scheduler unit 310 schedules threads for execution in groups of parallel threads, where each group is called a warp. In one embodiment, each warp includes 32 threads. The scheduler unit 310 may manage a plurality of different thread blocks, allocating the thread blocks to warps for execution and then scheduling instructions from the plurality of different warps on the various functional units (i.e., cores 350, DPUs 351, SFUs 352, and LSUs 353) during each clock cycle.

In one embodiment, each scheduler unit 310 includes one or more instruction dispatch units 315. Each dispatch unit 315 is configured to transmit instructions to one or more of the functional units. In the embodiment shown in FIG. 3, the scheduler unit 310 includes two dispatch units 315 that enable two different instructions from the same warp to be dispatched during each clock cycle. In alternative embodiments, each scheduler unit 310 may include a single dispatch unit 315 or additional dispatch units 315.

Each SM 250 includes a register file 320 that provides a set of registers for the functional units of the SM 250. In one embodiment, the register file 320 is divided between each of the functional units such that each functional unit is allocated a dedicated portion of the register file 320. In another embodiment, the register file 320 is divided between the different warps being executed by the SM 250. The register file 320 provides temporary storage for operands connected to the data paths of the functional units.

Each SM 250 comprises L processing cores 350. In one embodiment, the SM 250 includes a large number (e.g., 192, etc.) of distinct processing cores 350. Each core 350 is a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 250 also comprises M DPUs 351 that implement double-precision floating point arithmetic, N SFUs 352 that perform special functions (e.g., copy rectangle, pixel blending operations, and the like), and P LSUs 353 that implement load and store operations between the shared memory/L1 cache 370 and the register file 320. In one embodiment, the SM 250 includes 64 DPUs 351, 32 SFUs 352, and 32 LSUs 353.

Each SM 250 includes an interconnect network 380 that connects each of the functional units to the register file 320 and the shared memory/L1 cache 370. In one embodiment, the interconnect network 380 is a crossbar that can be configured to connect any of the functional units to any of the registers in the register file 320 or the memory locations in shared memory/L1 cache 370.

In one embodiment, the SM 250 is implemented within a GPU. In such an embodiment, the SM 250 comprises J texture units 390. The texture units 390 are configured to load texture maps (i.e., a 2D array of texels) from the memory 204 and sample the texture maps to produce sampled texture values for use in shader programs. The texture units 390 implement texture operations such as anti-aliasing operations using mip-maps (i.e., texture maps of varying levels of detail). In one embodiment, the SM 250 includes 16 texture units 390.

The PPU 200 described above may be configured to perform highly parallel computations much faster than conventional CPUs. Parallel computing has advantages in graphics processing, data compression, biometrics, stream processing algorithms, and the like.

### Desktop Spanning

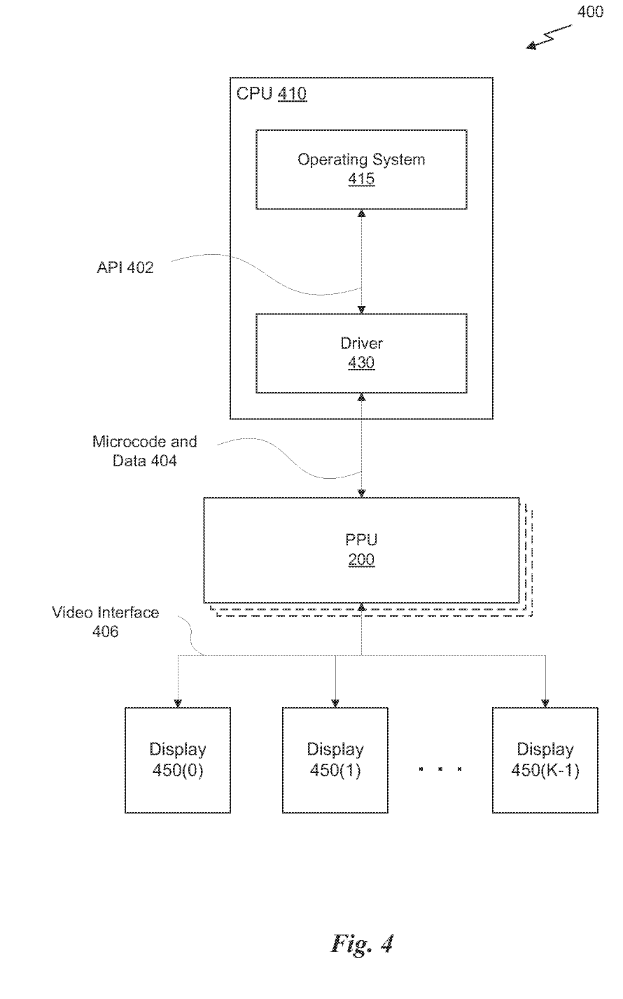

FIG. 4 illustrates a system 400 for implementing the desktop spanning environment, in accordance with one embodiment. As shown in FIG. 4, the system 400 includes a CPU 410, one or more PPUs 200, and a plurality of physical display devices 450. In one embodiment, desktop spanning is implemented on K physical display devices 450 coupled to the one or more PPUs 200 via a video interface 406. The video interface 406 may be any conventional video interface well-known in the art, such as Video Graphics Array (VGA), Digital Visual Interface (DVI), or DisplayPort (DP). The CPU 410 executes an operating system 415 and a display driver 430. The operating system 415 may be an operating system such as Microsoft™ Windows, Apple™ OSX, or one of the distributions of the Linux™ kernel such as Ubuntu™ Linux.

In one embodiment, the physical display devices 450 may be configured as a desktop spanning environment. In the desktop spanning environment, a display grid is defined as m rows×n columns of display devices 450 (i.e., an m×n display grid). For example, the system 400 may include three physical display devices 450 arranged adjacent to each other left-to-right, in a 1×3 display grid. Each display may be, e.g., a 1920×1080 resolution LCD display device. The desktop spanning environment establishes a logical surface having a resolution of 5760×1080 pixels. In other words, the logical surface displayed on the spanned desktop environment is three times as wide as a surface that can be displayed on a single display device 450. In another example, the system 400 may include four physical display devices 450 arranged in a 2×2 display gridx. The desktop spanning configuration establishes a logical surface having a resolution of 3840×2160 pixels. In other words, the surface displayed on the spanned desktop is twice as wide and twice as high as a surface that can be displayed on a single display device 450. In yet other embodiments, the display grid may have different dimensions such as a 3×1 display grid, a 3×3 display grid, a 4×3 display grid, and so forth.

As used herein, a logical surface is a data structure that stores pixel data for display on a physical display device 450. For example, a surface may comprise a frame buffer stored in a memory. The PPU 200 may render graphics data generated by an application to generate pixel data stored in the frame buffer. The pixel data is then transmitted to one or more of the physical display devices 450 for display. In one embodiment, the operating system 415 as well as one or more applications (not shown) may implement API calls 402 that are received by a display driver 430. The display driver 430 implements the API and generates microcode and data 404 that are transmitted to the one or more PPUs 200. The PPUs 200 generate pixel data in one or more frame buffers, and the pixel data is transmitted to the physical display devices 450 as video signals to generate images on the display devices 450.

In one embodiment, the CPU 410 may implement, via the operating system 415 and the display driver 430, a spanned desktop environment. The PPUs 200 may detect that one or more physical display devices 450 are connected to the system 400 at start-up. The PPUs 200 may notify the CPU 410 that a number of display devices 450 are connected to the system 400. The operating system 415 may then set up a display topology for the spanned desktop environment. The CPU 410, via the display driver 430, establishes one or more logical surfaces in a memory and configures the PPUs 200 to generate pixel data for the logical surfaces. The PPUs 200 fill the logical surfaces with pixel data. Once an image to be displayed has been generated in the logical surfaces, the PPUs 200 are configured to generate one or more video signals to transmit to the display devices 450.

In one embodiment, each PPU 200 is connected, via video interface 406, to one or more of the display devices 450 included in the display grid. For example, the system 400 may include three PPUs 200 coupled to three corresponding display devices 450, each PPU 200 allocated to a particular display device 450. In other embodiments, each PPU 200 may be connected to two or more display devices 450 in the display grid.

The display driver 430 may allocate a portion of the image generated by the one or more PPUs 200 to different display devices 450 for display to a user. For example, for a 2×2 display grid, the display driver 430 may allocate an upper left quadrant of the image to a first display device 450(0), an upper right quadrant of the image to a second display device 450(1), a lower left quadrant of the image to a third display device 450(2), and a lower right quadrant of the image to a fourth display device 450(3). The display driver 430 may then configure each of the PPUs 200 connected to the display devices 450 to generate video signals representing the portion of the image allocated to a corresponding display device 450 for transmission to each of the display devices 450.

In one embodiment, the display driver 430 configures each of the PPUs 200 to delay the video signal for each display device 450 based on the position of the display device 450 in the display grid. For example, a first PPU 200 corresponding to a first display device 450(0) that is configured to display the portion of an image for the upper left quadrant in a 2×2 display grid may begin transmitting a video signal for the first display device 450(0) at a time t₀. A second PPU 200 corresponding to a second display device 450(1) that is configured to display the portion of an image for the upper right quadrant in the 2×2 display grid begins transmitting the video signal for the second display device 450(1) at a time t₁. The time t₁ is delayed relative to the time t₀ by a time equal to the refresh time required to update one line of pixels in the first display device 450(0). In other words, as the pixels in the first line of pixels (i.e., the top-most line of pixels) in the first display device 450(0) are refreshed from left to right, the video signal for the second display device 450(1) is delayed such that the pixels in the first line of pixels in the second display device 450(1) are refreshed, from left to right, beginning at a time after the first line of pixels in the first display device 450(0) have been refreshed. The delay causes the pixels on different display devices to be refreshed in a logical order as if the multiple display devices were a single display device. The additional lines of pixels are refreshed in a similar manner due to the relative timing of the video signals between the first display device 450(0) and the second display device 450(1).

Similarly, a third PPU 200 corresponding to a third display device 450(2) that is configured to display the portion of an image for the lower left quadrant in a 2×2 display grid may begin transmitting a video signal for the first display device 450(0) at a time t₂. The time t₂ is delayed relative to the time t₀ by a time equal to the refresh time required to update a full frame of pixels in the first display device 450(0). In other words, as the first display device 450(0) is refreshed, the video signal for the third display device 450(2) is delayed until the first display device 450(0) has been refreshed. Once the last line of pixels in the first display device 450(0) has been refreshed, then the video signal for the third display device 450(2) is transmitted to the third display device 450(2) and the first line of pixels in the third display device 450(2) is refreshed. In addition, a fourth PPU 200 corresponding to a fourth display device 450(3) that is configured to display the portion of an image for the lower right quadrant in a 2×2 display grid may begin transmitting a video signal for the fourth display device 450(3) at a time t₃. The time t₃ is delayed relative to the time t₀ by a time equal to the refresh time required to update a full frame of pixels in the first display device 450(0) as well as a first line of pixels in the third display device 450(2). In other words, the first line of pixels in the fourth display device 450(3) is refreshed after the first line of pixels in the third display device 450(2) has been refreshed.

In general, the delay implemented for a particular display device in an m×n display grid is as follows:

t(m,n)=t_{base}+(m−1)*r_{frame}+(n−1)*rₗᵢₙₑ (Eq. 1)

Where, in Equation 1, t_{base} is a start time for a video signal corresponding to a base display device (i.e., the upper left display device in the display grid), m is an index corresponding to the row of the display device in the display grid, n is an index corresponding to the column of the display device in the display grid, r_{frame} is a time required to refresh a full frame of pixels in a display device, and rₗᵢₙₑ is a time required to refresh a single line of pixels in a display device.

The delay between the video signals may be adjusted from the timing set forth above. In another embodiment, the time t₁ is delayed relative to the time t₀ by a time equal to the sum of the refresh time required to update one line of pixels in the first display device 450(0) plus a time associated with refreshing a number of pixels approximately equal to the width of a bezel distance between the first display device 450(0) and the second display device 450(1). In other words, the timing of the second video signal is delayed an additional amount to account for the gap of pixels between the right edge of the display surface of the first display device 450(0) and the left edge of the display surface of the second display device 450(1). Similarly, the time t₂ is delayed relative to the time t₀ by a time equal to the sum of the refresh time required to update a full frame of pixels in the first display device 450(0) plus a time associated with refreshing a number of lines of pixels approximately equal to the height of a bezel distance between the first display device 450(0) and the third display device 450(2). In still other embodiments, the delay between the video signals may be less than the delay set forth above. For large display grids having a large number of displays, the cascading nature of the delays may cause a significant reduction in the effective frame rate for the entire display surface. In such cases, a smaller delay may be utilized, such as a delay approximately equal to the refresh time required to update half a line of pixels in the first display device 450(0) or half a frame of pixels in the first display device 450(0). The exact timing for the delayed signals may be set within a range from no delay to multiples of r_{frame} and rₗᵢₙₑ. A balance may be achieved between reducing the discontinuity between edges across physical display devices and the corresponding effective frame rate.

In yet another embodiment, each frame may be transmitted to the display devices two or more times. In other words, the upper portion of the current frame (i.e., frame n) is transmitted to each of the display devices 450 in the first row of the display grid. The display devices 450 in the first row of the display grid are refreshed using the upper portion of the current frame while the display devices 450 in the second row of the display grid are refreshed using the lower portion of the previous frame (i.e., frame n−1). Then, the upper portion of the current frame is re-transmitted to each of the display devices 450 in the first row of the display grid and the lower portion of the current frame is transmitted to each of the display devices 450 in the second row of the display grid. In other words, the video signals for the display devices 450 in each row of the display grid are delayed by a number of frames equal to the number of rows in the display grid minus one, and the same frame is retransmitted (or refreshed from a buffered memory local to the display device 450) to the display device for m number of frames, where m is the number of rows in the display grid.

FIG. 4 illustrates a system 400 with a single CPU 410 and one or more PPUs 200. It will be appreciated that multiple systems 400 may be connected to the plurality of display devices 450 and configured to operate in concert. In other words, two or more CPUs 410 may be configured to communicate, such as with one CPU acting as a master device and one or more other CPUs acting as slave devices, where each CPU is coupled to one or more PPUs 200 coupled to at least a portion of the display devices 450 in the display grid.

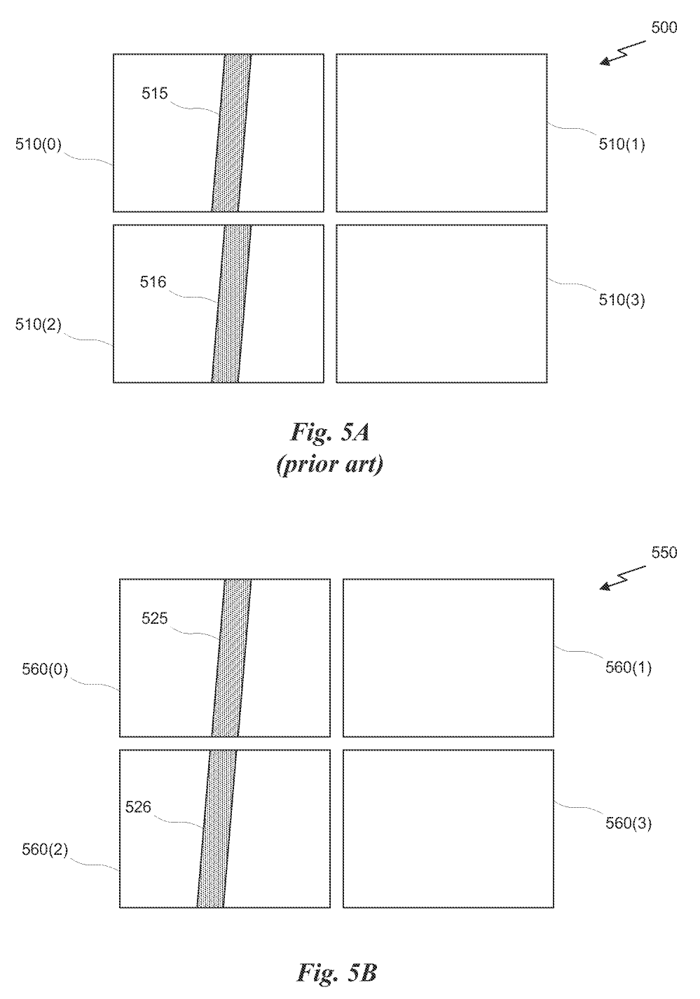

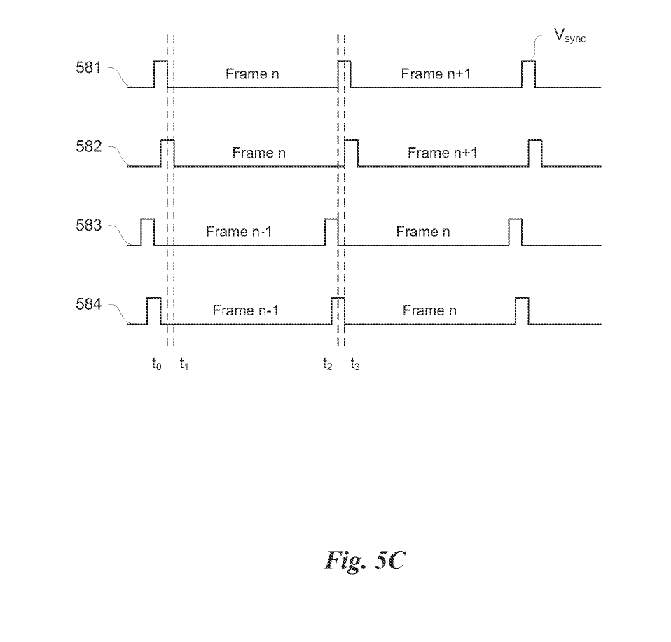

FIG. 5A illustrates a spanned desktop environment 500 showing a tearing artifact, in accordance with the prior art. The spanned desktop environment 500 includes four display devices 510(0), 510(1), 510(2), and 510(3) arranged in a 2×2 display grid. Some types of display devices (e.g., LCD display devices) generate image artifacts when displaying objects in motion. For example, a vertical bar may be generated by the PPUs 200 to be displayed on the spanned desktop environment 500. In the pixel data for the logical surface, the bar appears vertical. However, as the bar is moved from left to right across multiple frames of video, the bar will appear to be slightly tilted. The tilt appears due to image persistence of the pixels and a given refresh rate of the monitor.

As shown in FIG. 5A, a vertical bar 515, in motion, may appear tilted on the first display device 510(0) in a spanned desktop environment. Because the lines of pixels in the first display device 510(0) are refreshed from top to bottom, the lines of pixels at the bottom of the first display device 510(0) will be more recently refreshed than the lines of pixels at the top of the first display device 510(0) at the end of a video signal for the frame (i.e., during the Vsync period of the video signal). In other words, the pixels at the top of the screen will be refreshed at approximately a time t₀ and the pixels at the bottom of the screen will be refreshed at approximately a time t₀+r_{frame}. The response time of a pixel and the ability of a particular pixel to hold a charge will affect the amount of tilt that affects the resulting image displayed on the first display screen. As time passes since the last time a pixel has been refreshed, the voltage level of the pixel may leak, lowering the brightness of the pixel slightly. Furthermore, as the bar moves off of pixels, the voltage level of the pixels may change dramatically. However, the color of the pixel only changes based on the response time of the pixel. Therefore, the pixels that the bar has moved off of in a particular frame will be changed from the color of the bar to another color, but the pixel takes a specific time to react to the voltage change. Similarly, the pixels that the bar has moved on to in a particular frame will be changed from the other color to the color of the bar. As time goes by, the pixels for the bar change to represent the actual pixel data represented in the video signal. Because the top of the screen is refreshed before the bottom of the screen, the lower pixels may not have responded as much as the upper pixels, thereby generating the tilting artifact.

In conventional arrays of display devices, the video signals for each of the display devices may be transmitted to each of the display devices substantially simultaneously. Therefore, the first line of pixels in each of the display devices participating in the spanned desktop environment would be refreshed at approximately the same time. The result is that objects in motion may appear discontinuous. This artifact is sometimes referred to as a tearing artifact. As shown in FIG. 5A, the vertical bar 515 displayed on the first display device 510(0) should be the same vertical bar as displayed on the third display device 510(2). However, because both of the display devices 510(0) and 510(2) are refreshed substantially at the same time, both the upper portion of the bar 515 and the lower portion of the bar 516 appear tilted. The result is that the vertical bar appears discontinuous. Although not shown explicitly, similar artifacts can appear on adjacent displays arranged left to right when objects are moving from the top to the bottom of the screen or from the bottom to the top of the screen.

FIG. 5B illustrates a spanned desktop environment 550 that implements an artifact correction technique, in accordance with one embodiment. The spanned desktop environment 550 includes four display devices 560(0), 560(1), 560(2), and 560(3) arranged in a 2×2 display grid. In the spanned desktop environment 550, the video signals to each of the display devices 560 are delayed based on the location of the display device 560. In one embodiment, the video signals may be delayed by varying the synchronized timing of the video signals. The video signals may include synchronization signals that indicate separation between pixel data of different frames using a vertical synchronization (Vsync) signal and separation between pixel data of different lines using a horizontal synchronization (Hsync) signal. The display devices 560 may be synchronized by adjusting the timing between the various synchronization signals of the different video signals. In one embodiment, the first display device 560(0) is a base unit and lines of pixels in the display device 560(0) are refreshed (i.e., updated) from left to right and top to bottom. Because the pixels in the third display device 560(2) are updated after the pixels in the first display device 560(0), the representations of the bar 525 and 526, while still appearing tilted due to the same image persistence issues discussed before, no longer reflect the tearing artifact because the order that pixels are refreshed is maintained in a uniform manner across display device boundaries. Although not shown explicitly, similar artifacts can be reduced on adjacent displays arranged left to right when objects are moving from the top to the bottom of the screen or from the bottom to the top of the screen.

As shown in FIG. 5B, the video signal for the first display device 560(0) begins refresh of the pixels in the first display device 560(0) at a time t₀. In other words, a Vsync signal in the video signal corresponding to the first display device 560(0) transitions low at time t₀ indicating that the next data in the video signal represents data for pixels in the first line of pixels in the first display device 560(0). The video signal for the second display device 560(1) begins refresh of the pixels in the second display device 560(1) at a time t₁. Again, a Vsync signal in the video signal corresponding to the second display device 560(1) transitions low at time t₁ indicating that the next data in the video signal represents data for pixels in the first line of pixels in the second display device 560(1). The difference between t₀ and t₁ is equal to rline for the first display device 560(0) such that after the pixel data for the last pixel in the first line of pixels of the first display device 560(0) is transmitted to the first display device 560(0), the Vsync signal in the video signal corresponding to the second display device 560(1) transitions low and the pixel data for the first line of pixels in the second display device 560(1) is transmitted to the second display device 560(2).

Once all of the pixel data for the first display device 560(0) has been transmitted to the first display device 560(0), the video signal for the third display device 560(2) begins refresh of the pixels in the third display device 560(2) at a time t₂. A Vsync signal in the video signal corresponding to the third display device 560(2) transitions low at time t₂ indicating that the next data in the video signal represents data for pixels in the first line of pixels in the third display device 560(2). Similarly, the video signal for the fourth display device 560(3) begins refresh of the pixels in the fourth display device 560(3) at a time t₃. A Vsync signal in the video signal corresponding to the fourth display device 560(3) transitions low at time t₃ indicating that the next data in the video signal represents data for pixels in the first line of pixels in the fourth display device 560(3).

FIG. 5C shows a timing diagram for the video signals transmitted to the display devices 450 participating in a spanned desktop environment, in accordance with one embodiment. As shown in FIG. 5C, a first video signal 581 corresponds to a first display device 560(0). At a time t₀, the Vsync signal of the first video signal 581 transitions low and the pixel data for frame n is transmitted to the first display device 560(0) to update the pixels on the first display device 560(0). A second video signal 582 corresponds to a second display device 560(1). At a time t₁, the Vsync signal of the second video signal 582 transitions low and the pixel data for frame n is transmitted to the second display device 560(1) to update the pixels on the second display device 560(1). The difference between t₀ and t₁ is equal to the time it takes to refresh one line of pixels on the first display device 560(0). Again, the first display device 560(0) corresponds to a display located in a first row and a first column of a 2×2 display grid, and the second display device 560(1) corresponds to a display located in a first row and a second column of a 2×2 display grid.

Similarly, a third video signal 583 corresponds to a third display device 560(2). At a time t₂, the Vsync signal of the third video signal 583 transitions low and the pixel data for frame n is transmitted to the third display device 560(2) to update the pixels on the third display device 560(2). A fourth video signal 584 corresponds to a fourth display device 560(3). At a time t₃, the Vsync signal of the fourth video signal 584 transitions low and the pixel data for frame n is transmitted to the fourth display device 560(3) to update the pixels on the fourth display device 560(3). The difference between t₀ and t₂ is equal to the time it takes to refresh one frame of pixels on the first display device 560(0). Again, the third display device 560(2) corresponds to a display located in a second row and the first column of a 2×2 display grid, and the fourth display device 560(3) corresponds to a display located in the second row and the second column of a 2×2 display grid.

The timing diagrams shown in FIG. 5C are associated with a spanned desktop environment that implements a 2×2 display grid. It will be appreciated that additional video signals with different delays may be generated for spanned desktop environments that implement display grids of different dimensions.

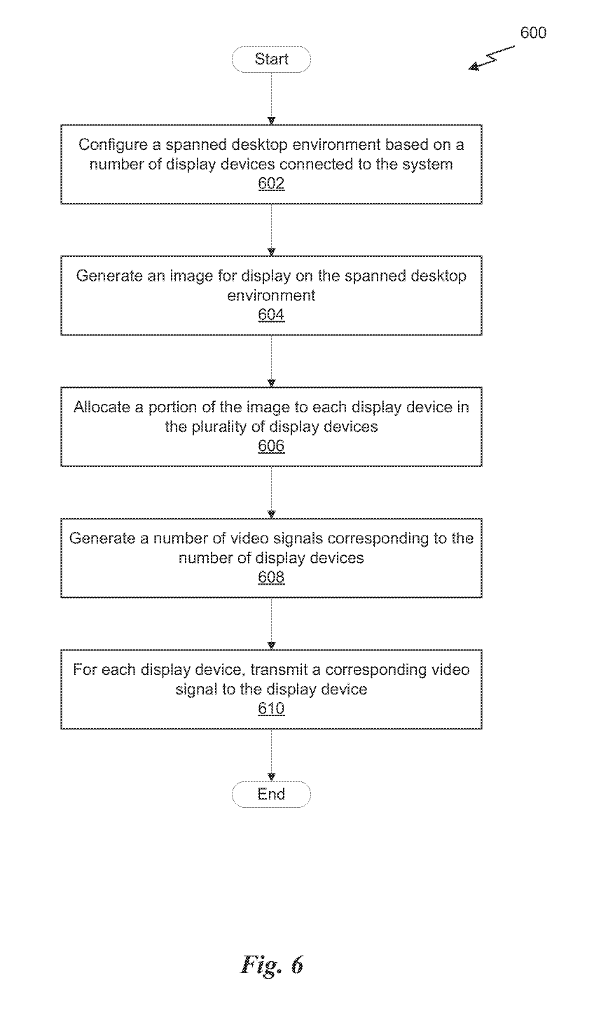

FIG. 6 illustrates a flowchart of a method for synchronizing multiple display devices participating in a spanned desktop environment, in accordance with another embodiment. At step 602, an operating system 415 configures a spanned desktop environment based on the number of display devices connected to the system 400. In one embodiment, when a system 400 is powered on, one or more PPUs 200 detect how many display devices 450 are connected to the system 400 and report the number of display devices 450 to the operating system 415. Based on the number of display devices 450 detected and, potentially, a previous configuration of the display grid associated with the number of display devices 450 (e.g., such as a stored configuration associated with the number and stored in the system register), the operating system 415 may automatically generate a display topology based on an arrangement of the display devices in an m×n display grid. At step 604, the display driver 430 configures the PPUs 200 to generate an image for display on the spanned desktop environment. Each PPU 200 may be allocated a different portion of the graphics data to render in order to generate pixel data for the image. The pixel data may be stored in memory as a logical surface. In another embodiment, a single PPU 200 may render the graphics data to generate the image data and then one or more PPUs 200 may be configured to generate the video signals for transmission to the display devices 450.

At step 606, the display driver 430 allocates a portion of the image to each display device 200 in the plurality of the display devices. In one embodiment, the display driver 430 splits the image up by dividing the image into a number of portions (e.g., equal to m×n portions) and assigning each portion to a different display device 450. At step 608, the PPUs 200 generate a number of video signals corresponding to the number of display devices 450 connected to the system 400 and configured to participate in the spanned desktop environment. Each video signal may be delayed relative to a base time based on the position of the corresponding display device 450 in the display grid. At step 610, the PPUs 200 transmit the video signals to the corresponding display devices 450.

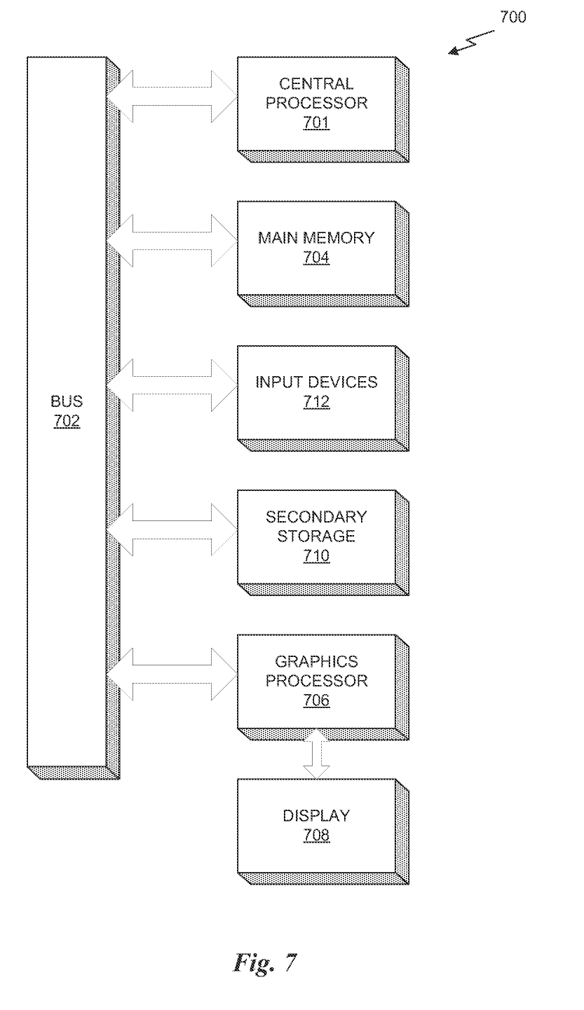

FIG. 7 illustrates an exemplary system 700 in which the various architecture and/or functionality of the various previous embodiments may be implemented. As shown, a system 700 is provided including at least one central processor 701 that is connected to a communication bus 702. The communication bus 702 may be implemented using any suitable protocol, such as PCI (Peripheral Component Interconnect), PCI-Express, AGP (Accelerated Graphics Port), HyperTransport, or any other bus or point-to-point communication protocol(s). The system 700 also includes a main memory 704. Control logic (software) and data are stored in the main memory 704 which may take the form of random access memory (RAM).

The system 700 also includes input devices 712, a graphics processor 706, and a display 708, i.e. a conventional CRT (cathode ray tube), LCD (liquid crystal display), LED (light emitting diode), plasma display or the like. In one embodiment, the display 708 comprises two or more physical display devices 450 configured to participate in a spanned desktop environment. User input may be received from the input devices 712, e.g., keyboard, mouse, touchpad, microphone, and the like. In one embodiment, the graphics processor 706 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 700 may also include a secondary storage 710. The secondary storage 710 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 704 and/or the secondary storage 710. Such computer programs, when executed, enable the system 700 to perform various functions. The memory 704, the storage 710, and/or any other storage are possible examples of computer-readable media.

In one embodiment, the architecture and/or functionality of the various previous figures may be implemented in the context of the central processor 701, the graphics processor 706, an integrated circuit (not shown) that is capable of at least a portion of the capabilities of both the central processor 701 and the graphics processor 706, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 700 may take the form of a desktop computer, laptop computer, server, workstation, game consoles, embedded system, and/or any other type of logic. Still yet, the system 700 may take the form of various other devices including, but not limited to a personal digital assistant (PDA) device, a mobile phone device, a television, etc.

Further, while not shown, the system 700 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
generating an image for display on a spanned desktop environment that includes a plurality of display devices;
allocating a portion of the image to each display device in the plurality of display devices; and
for each display device, transmitting a video signal to the display device that represents the portion of the image allocated to that display device, wherein the timing of the video signal is based on a relative position of the display device in a display grid.

2. The method of claim 1, wherein a first video signal transmitted to a first display device in the plurality of display devices is delayed relative to a second video signal transmitted to a second display device in the plurality of display devices.

3. The method of claim 2, wherein the first display device is included in a first row and a first column of the display grid and the second display device is included in a second row and the first column of the display grid, and wherein the first row is located directly below the second row in the display grid.

4. The method of claim 3, wherein the first video signal is delayed by a delay time corresponding to a time required to refresh one frame of pixels in the second display device.

5. The method of claim 3, wherein a third video signal transmitted to a third display device in the plurality of display devices is delayed relative to the second video signal.

6. The method of claim 5, wherein the third display device is included in a third row and the first column of the display grid, wherein the third row is located directly below the first row in the display grid, and wherein the third video signal is delayed by a delay time corresponding to a sum of a time required to refresh one frame of pixels in the second display device and a time required to refresh one frame of pixels in the first display device.

7. The method of claim 2, wherein the first display device is included in a first row and a first column of the display grid and the second display device is included in the first row and a second column of the display grid, and wherein the first column is located directly to the right of the second column in the display grid.

8. The method of claim 7, wherein the first video signal is delayed by a delay time corresponding to a time required to refresh one line of pixels in the second display device.

9. The method of claim 7, wherein a third video signal transmitted to a third display device in the plurality of display devices is delayed relative to the first video signal, wherein the third display device is included in the first row and a third column of the display grid, wherein the third column is located directly to the right of the first column in the display grid, and wherein the third video signal is delayed by a delay time corresponding to a sum of a time required to refresh one line of pixels in the second display device and a time required to refresh one line of pixels in the first display device.

10. The method of claim 1, wherein generating the image for display comprises rendering a plurality of graphics objects to generate pixel data associated with a plurality of pixels included in a logical display surface.

11. The method of claim 10, wherein dimensions of the logical display surface comprise the sum of the dimensions of the plurality of display devices.

12. The method of claim 1, wherein each video signal is generated by a particular parallel processing unit of two or more parallel processing units.

13. A non-transitory computer-readable storage medium storing instructions that, when executed by a processor, cause the processor to perform steps comprising:
generating an image for display on a spanned desktop environment that includes a plurality of display devices;
allocating a portion of the image to each display device in the plurality of display devices; and
for each display device, transmitting a video signal to the display device that represents the portion of the image allocated to that display device, wherein the timing of the video signal is based on a relative position of the display device in a display grid.

14. The computer-readable storage medium of claim 13, wherein a first video signal transmitted to a first display device in the plurality of display devices is delayed relative to a second video signal transmitted to a second display device in the plurality of display devices.

15. The computer-readable storage medium of claim 14, wherein the first display device is included in a first row and a first column of the display grid and the second display device is included in a second row and the first column of the display grid, and wherein the first row is located directly below the second row in the display grid.

16. The computer-readable storage medium of claim 15, wherein a third video signal transmitted to a third display device in the plurality of display devices is delayed relative to the second video signal, wherein the third display device is included in a third row and the first column of the display grid, wherein the third row is located directly below the first row in the display grid, and wherein the third video signal is delayed by a delay time corresponding to a sum of a time required to refresh one frame of pixels in the second display device and a time required to refresh one frame of pixels in the first display device.

17. The computer-readable storage medium of claim 14, wherein the first display device is included in a first row and a first column of the display grid and the second display device is included in the first row and a second column of the display grid, wherein the first column is located directly to the right of the second column in the display grid, and wherein the first video signal is delayed by a delay time corresponding to a time required to refresh one line of pixels in the second display device.

18. A system, comprising;
a plurality of display devices arranged in a spanned desktop environment; and
one or more processors configured to:
generate an image for display on the spanned desktop environment,
allocate a portion of the image to each display device in the plurality of display devices, and
for each display device, transmit a video signal to the display device that represents the portion of the image allocated to that display device, wherein the timing of the video signal is based on a relative position of the display device in a display grid.

19. The system of claim 18, wherein a first video signal transmitted to a first display device in the plurality of display devices is delayed relative to a second video signal transmitted to a second display device in the plurality of display devices.

20. The system of claim 18, wherein each processor in the one or more processors comprises a parallel processing unit.
